(19) United States
(12) Patent Application Publication
(10) Pub. No.: US 2014/0290235 A1
(43) Pub. Date: Oct. 2, 2014

(54) TORQUE CONVERTER

(71) Applicant: Takao Fukunaga, Yawata-shi (JP)

(72) Inventor: Takao Fukunaga, Yawata-shi (JP)

(73) Assignee: EXEDY CORPORATION, Neyagawa-shi, Osaka (JP)

(21) Appl. No.: 14/353,363

(22) PCT Filed: Aug. 8, 2012
(86) PCT No.: PCT/JP2012/070264

§ 371 Date: Apr. 22, 2014

(30) Foreign Application Priority Data
Nov. 24, 2011 (JP) 2011-255883

(51) Int. Cl. F16H 47/06

(52) U.S. Cl. CPC F16H 47/06
USPC 60/330

(57) ABSTRACT

A torque converter is provided that basically includes a front cover, an impeller, a turbine and a stator. The impeller core includes a plurality of impeller blades and an impeller core. The impeller core has a first protruded portion that protrudes axially from outlet-side end edges of the impeller blades. The turbine includes a turbine core and a plurality of turbine blades disposed in opposition to the impeller blades. The turbine core includes a second protruded portion that protrudes axially from inlet-side end edges of the turbine blades. The second protruded portion is located on an inner peripheral side of the first protruded portion and extends at least to a tip end of the first protruded portion.

### CROSS-REFERENCE TO RELATED APPLICATIONS

This application is a U.S. National stage application of International Application No. PCT/JP2012/070264, filed Aug. 8, 2012, which claims priority to Japanese Patent Application No. 2011-255883, filed in Japan on Nov. 24, 2011.

### BACKGROUND

1. Field of the Invention

The present invention relates to a torque converter for transmitting torque from an engine to a transmission using operating oil.

2. Background Information

A torque converter includes a front cover, an impeller, a turbine and a stator. Torque from an engine is transmitted to the front cover, and the torque transmitted to the front cover is then transmitted to the impeller. When the torque is transmitted to the impeller, the impeller is rotated and operating oil is moved towards the turbine. The turbine is rotated by means of the operating oil moved towards the turbine. At this time, the torque is transmitted from the turbine to a transmission-side shaft, and thereby, the transmission-side shaft is rotated. Further, the operating oil on the turbine side is returned towards the impeller through the stator.

In the torque converter as described above, when the torque inputted from the engine is large, it is required to increase the amount of the operating oil flowing within the torque converter and also to increase a capacity coefficient. To implement this, increase in size of the torque converter is required. In view of the above, Japanese Laid-Open Patent Application Publication No. 2000-291775 describes a torque converter having an impeller core and a turbine core. Here, the cores are made in the form of annular bars. Hence, the torque converter can maintain its required strength even when the cores are compactly formed, and the flow path area of the operating oil can be increased.

### SUMMARY

In the torque converter described in the above mentioned Japanese Publication, each of the impeller core and the turbine core is made of a ring-shaped member with a cross-section formed in either a circular shape or an oval shape. Therefore, the operating oil cannot be smoothly directed from the impeller to the turbine. Similarly, the operating oil cannot be also smoothly directed from the turbine to the stator. Therefore, a drawback is caused that the operating oil, flowing out of an impeller outlet towards the turbine, is sucked into an impeller inlet by means of the pump action of the impeller inlet, and thereby, a torque ratio is reduced.

It is an object of the present invention to increase the flow path area of operating oil, and further, to make the operating oil smoothly flow from an outlet of an impeller to an inlet of a turbine in order to inhibit the operating oil flowing out of the impeller from being sucked into the impeller.

A torque converter according to a first aspect of the present invention is the one for transmitting torque from an engine to a transmission by means of an operating oil, and includes a front cover, an impeller, a turbine and a stator. The front cover is configured to receive the torque that is inputted from the engine. The impeller includes a plurality of impeller blades and an impeller core. The impeller core has an annular shape and supports the impeller blades. The front cover and impeller core define an operating oil chamber therebetween. The turbine includes a turbine core and a plurality of turbine blades disposed in opposition to the impeller blades. The turbine core has an annular shape, and supports the turbine blades The turbine core is configured to output power to the transmission. The stator is disposed between an inner peripheral part of the impeller and an inner peripheral part of the turbine. The stator includes a stator core and a plurality of stator blades for regulating a flow of the operating oil flowing from the turbine to the impeller. The stator core has an annular shape and supports the stator blades. The impeller core has a first protruded portion that protrudes axially from outlet-side end edges of the impeller blades. The turbine core has a second protruded portion that protrudes axially from inlet-side end edges of the turbine blades. Further, the second protruded portion is located on an inner peripheral side of the first protruded portion and extends at least to a tip end of the first protruded portion.

In the torque converter, the operating oil flows from the impeller to the turbine, and further flows from the turbine to the impeller through the stator. In the stator, the flow of the operating oil is controlled. Here, the impeller core has the first protruded portion formed so as to be protruded from the outlet-side end edges of the impeller blades, whereas the turbine core has the second protruded portion formed so as to be protruded from the inlet-side end edges of the turbine blades. Therefore, the operating oil is smoothly directed from the impeller to the turbine. Further, the first protruded portion is extended at least to the tip end of the second protruded portion. Therefore, the operating oil, flowing out of the impeller, can be inhibited from flowing back to the impeller. Thus, reduction in torque ratio can be suppressed. Further, the flow path area can be increased without increasing the size of the torque converter, and a capacity coefficient can be increased.

A torque converter according to a second aspect of the present invention relates to the torque converter of the first aspect, and wherein the first protruded portion and the second protruded portion extend to an axially center position of a torus formed by the impeller blades, the turbine blades and the stator blades.

A torque converter according to a third aspect of the present invention relates to the torque converter of the first or second aspect, and wherein the first protruded portion and the second protruded portion axially overlap. Here, the operating oil, flowing out of the impeller, can be further inhibited from being sucked into the impeller inlet part.

A torque converter according to a fourth aspect of the present invention relates to the torque converter of any of the first to third aspects, and wherein in terms of axial position, the stator core is not formed in a region that the turbine core is disposed. Further, the second protruded portion has an inner diameter less than an outer diameter of the stator core, and axially overlaps with the stator blades. Here, the operating oil, flowing out of the turbine, smoothly flows into the stator while being directed by the second protruded portion of the turbine core.

### BRIEF DESCRIPTION OF THE DRAWINGS

FIG. 1 is a schematic vertical cross-sectional view of a torque converter according to an exemplary embodiment of the present invention.

FIG. 2 is an enlarged view of the center part of the torque converter.

FIG. 3 is a diagram corresponding to FIG. 2 according to another exemplary embodiment of the present invention.

FIG. 4 is a diagram corresponding to FIG. 2 according to yet another exemplary embodiment of the present invention.

### DESCRIPTION OF THE EMBODIMENTS

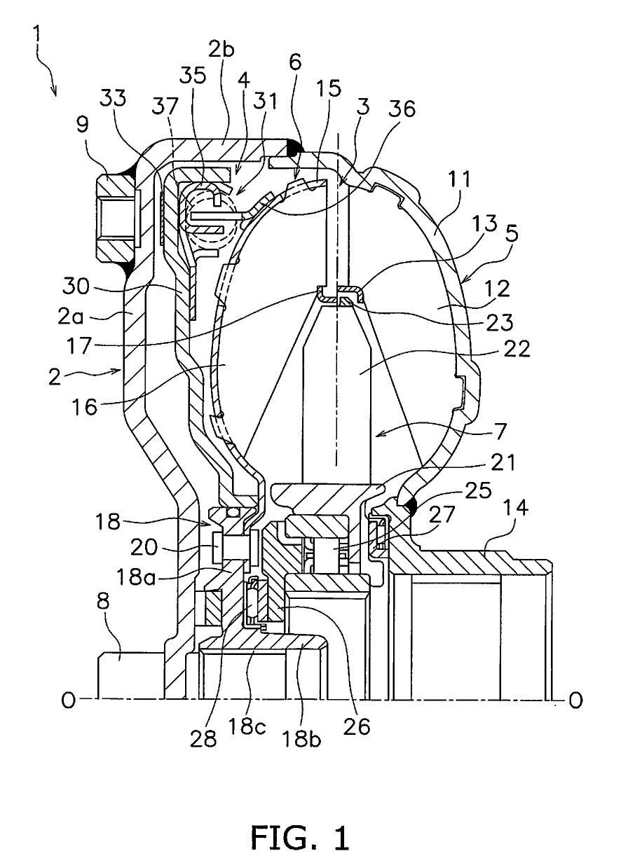

A torque converter 1 illustrated in FIG. 1 is a device for transmitting power from a crankshaft (not illustrated in the figures) of an engine to an input shaft (not illustrated in the figures) of a transmission. The engine (not illustrated in the figures) is disposed on the left side in FIG. 1, whereas the transmission (not illustrated in the figures) is disposed on the right side in FIG. 1. A line O-O depicted in FIG. 1 is a rotary axis of the torque converter 1.

As illustrated in FIG. 1, the torque converter 1 is composed of a front cover 2, a torque converter main body 3 and a lock-up device 4. The torque converter main body 3 includes an impeller 5, a turbine 6 and a stator 7. The front cover 2 has a disc part 2a and an outer peripheral tubular part 2b. A center boss 8 is fixed to the inner peripheral portion of the disc part 2a. The center boss 8 extends toward the engine. On the other hand, the disc part 2a has a plurality of nuts 9 fixed to the engine side of the outer peripheral portion of the disc part 2a. The nuts 9 are aligned at equal intervals in the circumferential direction. The outer peripheral tubular part 2b is extends from the outer peripheral portion of the disc part 2a towards the transmission. The impeller 5 is fixed to the tip end of the outer peripheral tubular part 2b by welding. As a result, the front cover 2 and the impeller 5 define an operating oil chamber that the inside thereof is filled with the operating oil.

The impeller 5 includes an impeller shell 11, a plurality of impeller blades 12, an impeller core 13 and an impeller hub 14. The outer peripheral part of the impeller shell 11 extends toward the engine. As described above, the tip end of the outer peripheral part of the impeller shell 11 is fixed to the outer peripheral tubular part 2b of the front cover 2 by welding. The impeller blades 12 are fixed to the inside of the impeller shell 11. The impeller core 13 has an annular shape, and supports the turbine side ends of the impeller blades 12. The impeller hub 14 extends toward the transmission, while being fixed to the inner peripheral part of the impeller shell 11.

The turbine 6 includes a turbine shell 15, a plurality of turbine blades 16, a turbine core 17 and a turbine hub 18. The turbine shell 15 is an annular member, and the inner peripheral part thereof extends toward the turbine hub 18. The turbine blades 16 are fixed to the impeller side surface of the turbine shell 15, while being disposed in opposition to the impeller blades 12. The turbine core 17 has an annular shape, and supports the impeller side ends of the turbine blades 16. The turbine hub 18 includes a flange part 18a and a tubular part 18b. The flange part 18a is formed in a disc shape. The tubular part 18b is formed on the inner peripheral end of the flange part 18a so as to extend axially. The inner peripheral end of the turbine shell 15 is fixed to the flange part 18a by rivets 20. Further, a spline hole 18c is formed on the inner peripheral surface of the tubular part 18b. The transmission-side input shaft (not illustrated in the figures) is allowed to be engaged with the spline hole 18c.

The stator 7 is a mechanism for regulating the flow of the operating oil returning from the turbine 6 to the impeller 5. The stator 7 is a member integrally formed by casting of resin, aluminum alloy or so forth. The stator 7 is disposed between the inner peripheral part of the impeller 5 and the inner peripheral part of the turbine 6. The stator 7 mainly includes a stator shell 21, a plurality of stator blades 22 and a stator core 23. The stator blades 22 are mounted to the outer peripheral surface of the stator shell 21. The stator core 23 has an annular shape, and is mounted to the tip ends of the stator blades 22. The stator shell 21 is supported by a stationary shaft (not illustrated in the figures) through a one-way clutch 25. Further, a retainer 26 is disposed on the axially engine side of the one-way clutch 25. The retainer 26 holds the one-way clutch 25, while being disposed between the one-way clutch 25 and the flange part 18a of the turbine hub 18.

Further, a thrust bearing 27 is mounted between the impeller hub 14 and the stator shell 21, while a thrust bearing 28 is mounted between the retainer 26 and the flange part 18a of the turbine hub 18.

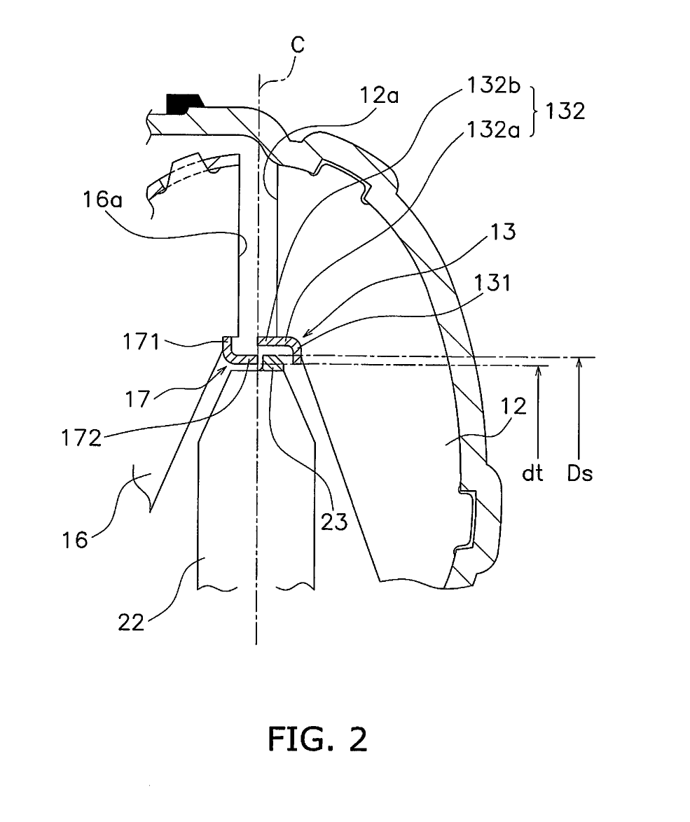

Next, the impeller core 13, the turbine core 17 and the stator core 23 will be explained in detail. As illustrated in FIG. 2, the impeller core 13 has: a radial part 131 that has an annular shape and extends radially; and an axial part 132 that is formed by bending the outer peripheral portion of the radial part 131 towards the engine so as to extend axially. The radial part 131 and a transmission-side portion 132a of the axial part 132 are fixed to the turbine-side end edges of the impeller blades 12. Further, an engine-side portion of the axial part 132 protrudes from outlet-side end edges 12a of the impeller blades 12, and is formed as a first protruded portion 132b. The first protruded portion 132b extends to an axially center position C of a torus formed by the impeller blades 12, the turbine blades 16 and the stator blades 22. In other words, the tip end of the first protruded portion 132b and the axially center position C of the torus are located axially in the same position.

The turbine core 17 has: a radial part 171 that has an annular shape and extends radially; and an axial part 172 that is formed by bending the inner peripheral portion of the radial part 171 towards the transmission so as to extend axially. The radial part 171 is fixed to the impeller-side end edges of the turbine blades 16. Further, a portion of the axial part 172 protrudes from inlet-side end edges 16a of the turbine blades 16, and the protruded portion is formed as a second protruded portion. The second protruded portion 172 is located on the further inner peripheral side than the first protruded portion 132b, while extending to the axially center position C of the torus. In other words, the tip end of the first protruded portion 132b and that of the second protruded portion 172 are located axially in the same position as the axially center position C of the torus.

As illustrated in FIG. 2, the stator core 23 is mounted only on the impeller side of the axially center position C of the torus. In other words, in terms of axial position, the stator core 23 is not formed in a region that the turbine core 17 is disposed. Moreover, an inner diameter dt of the second protruded portion 172 of the turbine core 17 is less than an outer diameter Ds of the stator core 23, and the second protruded portion 172 is disposed adjacently to the outer peripheral parts of the stator blades 22. Further, the second protruded portion 172 is axially overlapped with the stator blades 22.

As illustrated in FIG. 1, the lock-up device 4 includes a piston 30 and a damper mechanism 31. The piston 30 is a disc-shaped member that is disposed between the front cover 2 and the turbine 6. The inner peripheral part of the piston 30 is supported by the outer peripheral surface of the flange part 18a of the turbine hub 18, while being rotatable relatively thereto and axially movable. Further, a friction facing 33 is fixed to the engine side of the outer peripheral part of the piston 30. The friction facing 33 has an annular shape.

The damper mechanism 31 includes a retaining plate 35, a driven plate 36 and a plurality of torsion springs 37. The retaining plate 35 is fixed to the turbine side of the outer peripheral part of the piston 30. The retaining plate 35 has a plurality of cut-and-raised portions for accommodating and supporting the torsion springs 37. The torsion springs 37 are accommodated within the retaining plate 35, while the both circumferential ends of the respective torsion springs 37 are supported. The driven plate 36 is an annular plate that is fixed to the outer peripheral side of the turbine shell 15 of the turbine 6. The driven plate 36 has a plurality of protruded pawls that extends toward the front cover 2. The protruded pawls are respectively engaged with the both circumferential ends of the respective torsion springs 37.

Torque is transmitted from the crankshaft (not illustrated in the figures) of the engine to the front cover 2 and the impeller 5. The torque transmitted to the impeller 5 is transmitted to the turbine 6 using the operating oil, and is transmitted to the transmission-side input shaft coupled to the turbine hub 18. In the aforementioned action, the operating oil within the torus is caused to flow along the impeller shell 11 and the impeller blades 12 by the rotation of the impeller 5, and is directed towards the turbine 6. Within the turbine 6, the operating oil is caused to flow towards the stator 7 along the turbine shell 15 and the turbine blades 16. Further, the flow of the operating oil is regulated by the stator 7, and the operating oil is returned to the impeller 5.

Here, the impeller core 13 is provided with the first protruded portion 132b. Therefore, when the operating oil flows out of the impeller 5 towards the turbine 6, the operating oil, flowing out of the impeller 5, flows into the turbine 6 and can be inhibited from being sucked into the impeller 5 by the pump action of the impeller 5. When explained in more detail, the operating oil flowing out of the outlet part of the impeller 5 is likely to swirl into the inlet part of the impeller 5 in the position closest to the inlet-side ends of the impeller blades 12 within the outlet-side ends of the impeller blades 12, i.e., in the position that the impeller core 13 is disposed.

However, in the present exemplary embodiment, the first protruded portion 132b of the impeller core 13 extends to the axially center position C of the torus. The operating oil, flowing out of the impeller 5, can be thereby smoothly directed to the turbine 6. Additionally, the turbine core 17 is similarly provided with the second protruded portion 172, and the second protruded portion 172 extends to the axially center position C of the torus. Therefore, the operating oil, passing through the first protruded portion 132b, is directed towards the turbine 6 by the second protruded portion 172, and can be inhibited from being sucked into the inlet part of the impeller 5.

Further, the second protruded portion 172 is disposed adjacently to the outer peripheral parts of the stator blades 22, while being axially overlapped with the stator blades 22. Therefore, the operating oil, flowing out of the turbine 6, is smoothly directed to the stator 7 while being unlikely to leak to the outer peripheral side of the stator 7. In the exemplary embodiment as described above, the operating oil, flowing out of the impeller 5, can be inhibited from flowing back to the impeller 5, and reduction in torque ratio can be suppressed. Further, by applying the core shape of the present exemplary embodiment, the space of the torus middle part can be further reduced than that in a well-known torque converter having a normal core. Therefore, the flow path area of the torque converter can be increased without increasing the size of the torque converter, and a capacity coefficient can be increased.

Further, the inner diameter of the second protruded portion 172 is less than the outer diameter of the stator core 23, and the second protruded portion 172 is axially overlapped with the stator blades 22. Therefore, the operating oil, flowing out of the turbine 6, is smoothly directed to the stator 7.

### Other Exemplary Embodiments

The present invention is not limited to the aforementioned exemplary embodiment, and a variety of changes or modifications can be herein made without departing from the scope of the present invention.

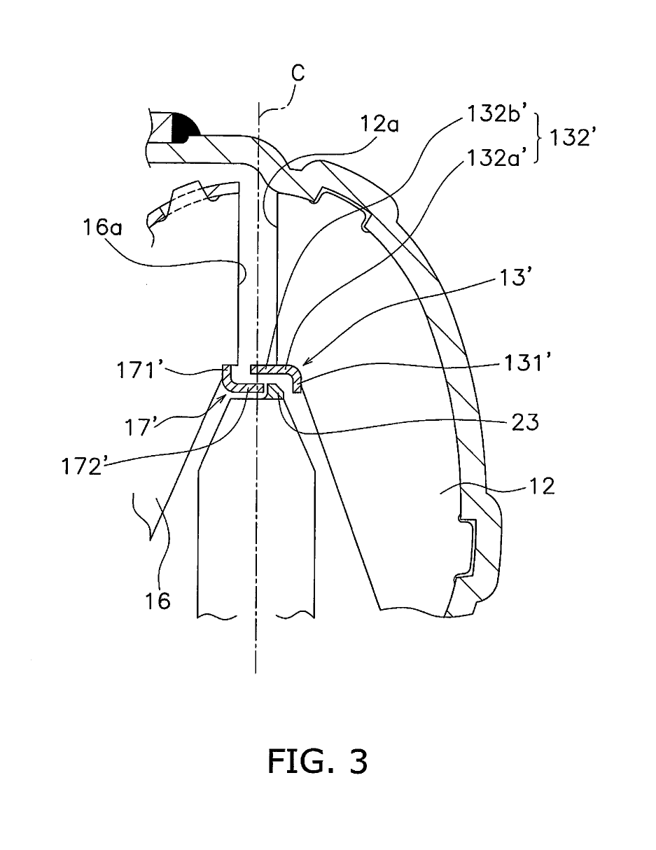

(1) FIG. 3 illustrates an impeller core and a turbine core according to another exemplary embodiment. In this exemplary embodiment, the shapes of the protruded portions of the respective cores are different from those of the aforementioned exemplary embodiment, whereas the other structures are similar to those of the aforementioned exemplary embodiment. Specifically, similarly to the aforementioned exemplary embodiment, an impeller core 13′ has a radial part 131′ and an axial part 132′. Further, the axial part 132′ has a transmission-side portion 132a′ and a first protruded portion 132b′. The transmission-side portion 132a′ is fixed to the impeller blades 12. The first protruded portion 132b′ is formed so as to be protruded from the outlet-side end edges 12a of the impeller blades 12. The first protruded portion 132b′ extends toward the turbine blades 16 across the axially center position C of the torus.

On the other hand, a turbine core 17′ has a radial part 171′ and an axial part 172′. Further, the axial part 172′ has a second protruded portion 172′ formed so as to protrude from the inlet-side end edges 16a of the turbine blades 16. The second protruded portion 172′ extends toward the impeller blades 12 across the axially center position C of the torus. In other words, the first protruded portion 132b′ and the second protruded portion 172′ axially overlap.

In the exemplary embodiment as described above, the operating oil, flowing out of the impeller 5, can be further inhibited from being sucked into the side of the impeller 5.

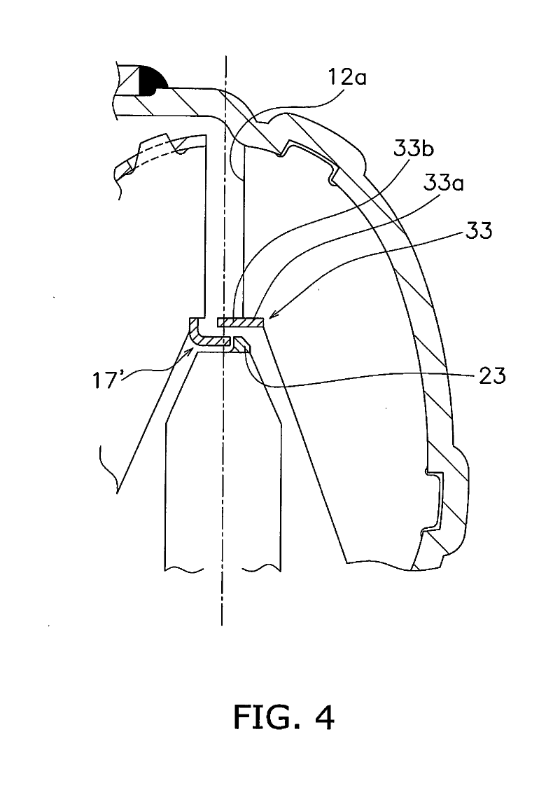

(2) FIG. 4 illustrates an impeller core according to yet another exemplary embodiment. The exemplary embodiment illustrated in FIG. 4 is different from that illustrated in FIG. 3 only regarding the structure of an impeller core. An impeller core 33 of this exemplary embodiment is formed in a tubular shape, and is only composed of an axial part without being composed of the radial part of the aforementioned exemplary embodiments. A transmission-side portion 33a of the impeller core 33 is fixed to the impeller blades 12, whereas an engine-side portion thereof is formed as a first protruded portion 33b protruded from the outlet-side end edges 12a of the impeller blades 12. The structure of the first protruded portion 33b is the same as that of the first protruded portion 132b′ in the exemplary embodiment illustrated in FIG. 3.

Even the exemplary embodiment herein described can achieve advantageous effects similar to those achieved by the aforementioned exemplary embodiments.

The torque converter of the present invention can increase the flow path area without increasing the entire size thereof, and can increase the capacity coefficient. Further, the operating oil can smoothly flow from the impeller outlet to the turbine inlet, and the operating oil flowing out of the impeller can be inhibited from being sucked into the impeller.

1. A torque converter for transmitting torque from an engine to a transmission using an operating oil, the torque converter comprising:
a front cover configured to receive the torque inputted from the engine;
an impeller including a plurality of impeller blades and an impeller core, the impeller core having an annular shape and supporting the impeller blades, the impeller and the front cover defining an operating oil chamber therebetween;
a turbine including a turbine core and a plurality of turbine blades disposed in opposition to the impeller blades, the turbine core having an annular shape and supporting the turbine blades, the turbine being configured to output. power to the transmission; and
a stator being disposed between an inner peripheral part of the impeller and an inner peripheral part of the turbine, the stator including a stator core and a plurality of stator blades for regulating a flow of the operating oil flowing from the turbine to the impeller, the stator core having an annular shape and supporting the stator blades,
the impeller core including a first protruded portion that protrudes axially from outlet-side end edges of the impeller blades,
the turbine core including a second protruded portion that protrudes axially from inlet-side end edges of the turbine blades, and
the second protruded portion being located on an inner peripheral side of the first protruded portion and extending at least to a tip end of the first protruded portion.

2. The torque converter as recited in claim 1, wherein the first protruded portion and the second protruded portion extend to an axially center position of a torus formed by the impeller blades, the turbine blades and the stator blades.

3. The torque converter as recited in claim 1, wherein
the first protruded portion and the second protruded portion axially overlap.

4. The torque converter as recited in claim 1, wherein
the stator core does not axially extend into a region that the turbine core is disposed, and
the second protruded portion has an inner diameter less than an outer diameter of the stator core, the second protruded portion axially overlapping the stator blades.

5. The torque converter as recited in claim 2, wherein
the first protruded portion and the second protruded portion axially overlap.

6. The torque converter as recited in claim 2, wherein
the stator core does not axially extend into a region that the turbine core is disposed, and
the second protruded portion has an inner diameter less than an outer diameter of the stator core, the second protruded portion axially overlapping the stator blades.

7. The torque converter as recited in claim 2, wherein
the stator core does not axially extend into a region that the turbine core is disposed, and
the second protruded portion has an inner diameter less than an outer diameter of the stator core, the second protruded portion axially overlapping the stator blades.
